(19) United States
(12) Patent Application Publication
(10) Pub. No.: US 2024/0101069 A1
(43) Pub. Date: Mar. 28, 2024

(54) VEHICLE WINDSHIELD WIPER DEVICE

(71) Applicant: Volvo Truck Corporation, Goteborg (SE)

(72) Inventors: K S Madhuchandra, Bangalore (IN); K S Sudeendra Thirtha Koushik, Bangalore (IN)

(21) Appl. No.: 18/468,791

(22) Filed: Sep. 18, 2023

(30) Foreign Application Priority Data
Sep. 23, 2022 (EP) 22197451.2

(51) Int. Cl. B60S 1/04; B60S 1/34

(52) U.S. Cl. CPC B60S 1/0433; B60S 1/3488

(57) ABSTRACT

A vehicle windshield wiper device comprising an articulated structure and a blade, the articulated structure comprising an arm transmitting mechanical forces to the blade, wherein the arm is mounted on an axle to provide an arm rotational movement corresponding to a wiping movement, wherein the arm is pivotably attached to the axle. The vehicle windshield wiper device also comprises an arm holder restraining the arm from pivoting when blade is in a parking position.

### RELATED APPLICATIONS

The present application claims priority to European Patent Application No. 22197451.2, filed on Sep. 23, 2022, and entitled “VEHICLE WINDSHIELD WIPER DEVICE,” which is incorporated herein by reference in its entirety.

### TECHNICAL FIELD

The invention relates to a vehicle windshield wiper device.

The invention can be applied in heavy-duty vehicles, such as trucks, buses and construction equipment. The invention is not restricted to this particular vehicle but may also be used in other vehicles such as car.

### BACKGROUND

On a medium duty or heavy-duty truck, windshield is usually at a high level. It is then unconformable and/or difficult to access the windshield for example in case of maintenance issue or to clean it when truck is stationary. To help user/driver to access windshield, foldable steps and/or grab handles are provided on the truck front. Grab handles are usually attached on truck front just below windshield. At same time, windshield wiper device is mounted on truck front but grab handles limit space available below windshield to attach windshield wiper device. In stationary position, wiper arms need to stay above grab handles. In that position, wiper blades occupy bottom area of windshield and then reduce driver visibly.

### SUMMARY

An object of the invention is to provide a vehicle windshield wiper device that could be also used as a handle to access to the windshield.

The object is achieved by a vehicle windshield wiper device comprising an articulated structure and a blade, articulated structure comprises an arm transmitting mechanical forces to blade, arm is mounted on an axle to provide an arm rotational movement corresponding to wiping movement, arm is pivotably attached to the axle, windshield wiper device also comprising an arm holder restraining arm from pivoting when blade is in parking position.

By restraining pivoting movement of the arm in parking position, the arm could be grabbed by a user to climb on the vehicle.

According to one embodiment, arm holder comprising a rigid bracket restraining arm from pivoting when blade is in parking position.

According to a further embodiment, arm holder comprising a rigid pin linked with rigid bracket (30) and cooperate with a corresponding hole made in arm.

According to a further embodiment, arm holder is located below windshield.

According to a further embodiment, arm holder comprising an electrically operated pin cooperate with a corresponding hole made in arm and having a first position restraining arm from pivoting when blade is in parking position and e second position allowing arm pivotable movement.

According to a further embodiment, arm comprising a handling section.

According to a further embodiment, handling section is located between arm holder and axle.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a schematic view of vehicle windshield equipped with wiper device;

FIG. 2 is a front detail view of articulated structure of wiper device;

FIG. 3 is a rear detail view of articulated structure of wiper device; and

FIG. 4 is sectional view of articulated structure of wiper device.

### DETAILED DESCRIPTION

It should be noted that in the detailed description that follows, identical or similar components, either from a structural and/or functional point of view, may have the same reference numerals, regardless of whether they are shown in different embodiments of the present disclosure; it should also be noted that in order to clearly and concisely describe the present disclosure, the drawings may not necessarily be to scale and certain features of the disclosure may be shown in somewhat schematic form.

Further, when the term “adapted” or “arranged” or “configured” or “shaped”, or “set” or any equivalent or similar term is used herein while referring to any component as a whole, or to any part of a component, or to a combination of components, it has to be understood that it means and encompasses correspondingly either the structure, and/or configuration and/or form and/or positioning of the related component or part thereof, or combinations, such term refers to.

In addition, when the term “substantial” or “substantially” is used herein, it has to be understood as encompassing an actual variation of plus or minus 5% with respect to an indicated reference value, or axis, or position, and when the terms transversal or transversally are hereby used, they have to be understood as encompassing a direction non-parallel to the reference part(s) or direction(s)/axis they refer to, and perpendicularity has to be considered a specific case of transverse direction.

Finally, in the following description and claims, the numeral ordinals first, second, et cetera . . . , will be used only for the sake of clarity of description and in no way they should be understood as limiting for whatsoever reason, nor that the order should be necessarily the one described in the illustrated exemplary embodiment(s).

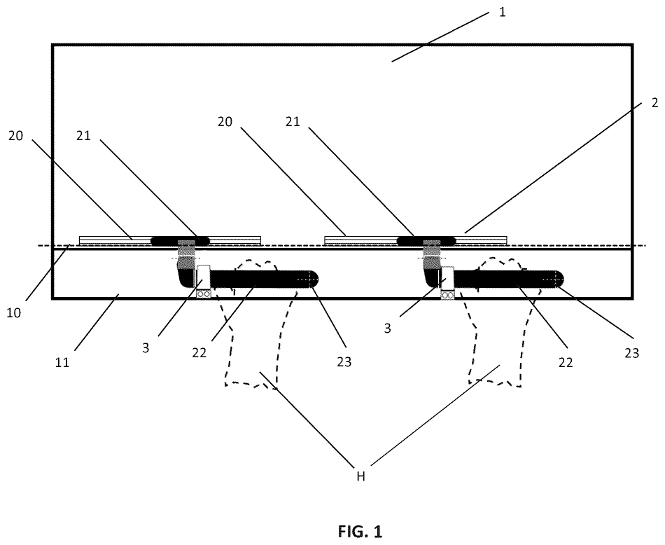

With reference to FIG. 1, a windshield 1 of a vehicle such as a truck is substantially rectangular. The windshield 1 is assembled on the structure (not shown) of the truck cab. In particular, the lower part of the windshield 1 is mounted on the structure 11 of the front of the truck.

In a manner known per se, the windshield 1 is equipped with a windshield wiper device 2. The windshield wiper device comprises at least one blade 20 in contact with the windshield and an articulated structure 21, 22 for transmitting a rotational movement to each blade 20. The rotational movement transmitted to each blade 20 allows them to sweep at least part of the surface of the windshield 1.

The articulated structure comprises a rotating arm 22 mounted on the front structure 11 of the truck cab. The axis of rotation 23 of the rotating arm is located at a first end. The second end of the rotating arm 22 includes a mounting device 21 for the brush 20. This mounting device 23 is known per se and allows the brush 20 to be changed when worn or damaged. The axis of rotation 23 of the arm 23 is substantially perpendicular to the windshield 1 so that the brush 20 runs along at least part of the surface of the windshield 1. When the brush 20 is not rotating, it is in the so-called parking position. In this position, the brush 20 occupies a low area of the windshield 2 close to the front structure 11 of the truck cab.

The rotating arm 22 is also mounted so that it can pivot in relation to the windscreen 1. The pivot axis of the rotating arm 22 is substantially parallel to the windshield. The pivoting of the rotating arm 22 allows the brush 20 to be moved away from the windshield, for example to replace the brush 20 or to clean the windshield 1. The pivot axis of the rotatable arm 22 is positioned on the first end.

According to a feature of the invention, the windshield wiper device 2 comprises a holding device 3 for the rotatable arm 22 preventing the rotatable arm 22 from pivoting when the blade 20 is in the parked position.

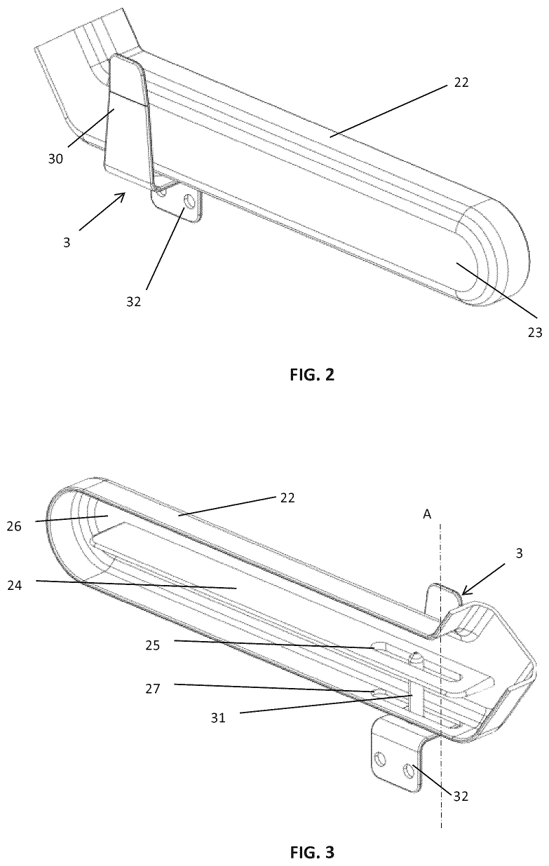

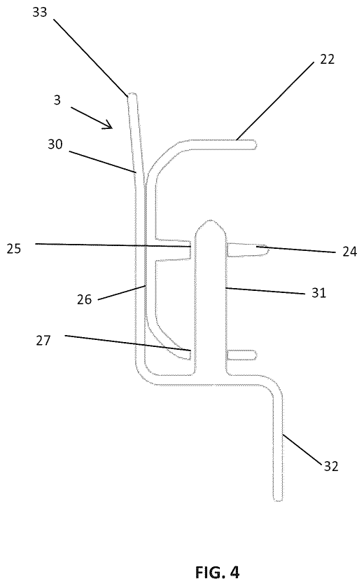

The holding device 3 will now be described in more detail with reference to FIGS. 2, 3 and 4. The holding device comprises a rigid bracket 30 forming a stop for the rotating arm 22 when the latter is in the parked position. In other words, when the broom 20 is in the parked position, the rotating arm 22 is placed between the rigid bracket 30 and the structure 11 of the front of the truck so that the pivoting movement of the rotating arm 22 is no longer possible.

The holding device 3 also includes a bracket 32 for fixing the rigid bracket 30 to the structure of the front of the truck. The attachment is made by screwing, welding or gluing. Thus, it is understood that when the broom 20 is in the parked position, a user H can grasp the rotating arm, for example, to climb onto the front of the truck without the rotating arm being able to pivot. The type of fastening is determined according to the structure 11 of the front of the truck and is able to support the weight of a user.

The holding device 3 may comprise a stud 31 oriented substantially parallel to the longitudinal axis A of the rigid bracket 30. The pin 31 passes through the rotating arm 22 through a first hole 27 in the rotating arm 23 when the broom 20 is in the parked position. The rotating arm 22 may include a reinforcing rib 24 to increase the resistance of the rotating arm 22 to the weight of the user. The reinforcing rib 24 is located on an inner face 26 of the rotating arm 22. The reinforcing rib 24 may include a second hole 25 through which the pad passes when the broom 20 is in the parked position. It is understood that the orientation of the pin 31, the first 27 and second 25 holes does not prevent the rotation of the rotating arm 22 but does prevent the pivoting of the rotating arm 22.

The rigid bracket 30 includes a flared portion 33 located in the upper part of the rigid bracket 30, opposite the mounting tab 32. This flared portion 33 allows for better positioning of the rotatable arm 22 within the rigid bracket 30 in a parked position. A portion of the rotatable arm 22 may include a gripping device such as a handle (not shown). The portion of the rotating arm 22 comprising the gripping device is located between the axis of rotation 23 of the rotating arm and the holding device 3.

According to the above embodiment, in the parked position the brush or brushes 20 are positioned in the lower part of the windshield. The rotating arm(s) 22 rest(s) in the rigid bracket 30. In this position, a user can grasp a rotating arm 22 with his hand H to access the windshield. No other handle is required. The space thus freed up allows for easier installation of the wiper device 2 so that the blade(s) 20 is positioned as low as possible on the windshield 1 and thus increases the user's viewing area through the windshield 1.

According to another embodiment, the holding device comprises an electrically controlled actuator. The actuator comprises a piston or plunger moving between an extended position and a folded position. In the extended position, the plunger interacts with the rotating arm 22 to block the movement is pivotal movement. For example, to block the pivotal movement of the rotating arm 22, the piston engages the first and/or second ports 25, 27 of the rotating arm 22. In the folded position, the piston no longer interacts with the rotating arm 22. The actuation of the piston in the extended position is carried out, for example, when the truck's ignition is switched off.

1. A vehicle windshield wiper device comprising:
an articulated structure and a blade;
wherein the articulated structure comprises an arm transmitting mechanical forces to the blade;
wherein the arm is mounted on an axle to provide an arm rotational movement corresponding to a wiping movement;
wherein the arm is pivotably attached to the axle; and
wherein the vehicle windshield wiper device further comprises an arm holder restraining the arm from pivoting when the blade is in a parking position.

2. The vehicle windshield wiper device of claim 1, wherein the arm holder further comprises a rigid bracket restraining the arm from pivoting when the blade is in the parking position.

3. The vehicle windshield wiper device of claim 2, wherein the arm holder further comprises a rigid pin linked with the rigid bracket and in cooperation with a corresponding hole made in the arm.

4. The vehicle windshield wiper device of claim 1, wherein the arm holder further comprises an electrically operated pin in cooperation with a corresponding hole made in the arm and having a first position restraining the arm from pivoting when the blade is in the parking position and a second position allowing the arm pivotable movement.

5. The vehicle windshield wiper device of claim 1, wherein the arm holder is located below a windshield.

6. The vehicle windshield wiper device of claim 1, wherein the arm further comprises a handling section.

7. The vehicle windshield wiper device of claim 6, wherein the handling section is located between the arm holder and the axle.
